(19) United States
(12) Patent Application Publication
(10) Pub. No.: US 2009/0048941 A1
(43) Pub. Date: Feb. 19, 2009

(54) Gathering Information About Assets

(76) Inventor: Steven Strassmann, Brookline, MA (US)

Correspondence Address: FISH & RICHARDSON PC, P.O. BOX 1022, MINNEAPOLIS, MN, 55440-1022, US

(21) Appl. No.: 11/839,860

(22) Filed: Aug. 16, 2007

(51) Int. Cl. G06F 17/30; G06Q 30/00

(52) U.S. Cl. 705/27; 707/3; 707/E17.108

(57) ABSTRACT

A sequence of steps for locating information of a particular type on a particular web site is received from a first process and stored in a database of sequences of steps. Upon an identification of the particular web site as likely to provide information related to a particular subject, the sequence of steps is retrieved from the database and the sequence of steps and an identification of the subject are provided to a second process. Information relating to the particular subject from the particular website is received from the second process.

### BACKGROUND

This disclosure relates to gathering information about assets.

One way to automatically gather, for example, information about consumer products on the World Wide Web uses a web crawler. Yahoo Shopping uses a web crawler to locate and extract information about products from sites belonging to vendors of those products. Crawlers aggregate the information they find or compile lists of where the information can be found again.

A web crawler may traverse the pages of a web site, retrieve a copy of HTML and other data contained on those pages, extract relevant data, and clean up and put the information into a format usable by the web crawler's operator. A web crawler typically traverses the pages by following every link that appears on each page to accumulate a copy of every page on a web site. This collection is then filtered to derive useful data, such as product pricing information.

### SUMMARY

In general, in one aspect, a web site is automatically identified as likely to provide information related to an identified subject, and a stored sequence of steps is automatically followed to interact with features of the website to locate information of a particular type related to the identified subject, including for at least one of the steps retrieving the information.

Implementations may include one or more of the following features. The retrieved information is provided. A website is generated displaying the retrieved information. The particular type of information includes information about products. The information about products includes one or more of user manuals, specifications, software, prices, accessories, support information, and updates. The identified subject includes an identification of a product. The identification of the product includes one or more or a combination of a product ID number, a trademark, a brand name, a manufacturer, a common name, or a UPC code number. The web site includes one or more of a search engine, a manufacturer's website, a retailer's website, or a data aggregating web site. A second web site likely to provide information related to the identified subject is automatically identified, and a second stored sequence of steps is automatically followed to interact with features of the second website to locate information of a second particular type related to the identified subject, including for at least one of the steps retrieving the information. The second web site is a separate website from the first web site. Automatically identifying the web site includes using an internet search engine to search for sites related to the identified subject, and identifying a result of the search for which a sequence of steps is available. Automatically storing the retrieved information and, at a time later than the storing, automatically associating the stored information with a sales listing for the identified product. Associating the stored information comprises, in communication with a second web site, automatically identifying a sales listing offering the identified product; and automatically adding the stored information to the sales listing. Associating the retrieved information includes automatically identifying a description of the product within the retrieved information, and in communication with a second website, automatically initiating generation of a web page to sell the product, adding the description of the product to the web page, and causing the web page to be available to potential buyers of the product. A resale price of the product is identified within the retrieved information and adding the resale price to the web page.

In general, in one aspect, a web site is automatically interacted with to determine a sequence of steps for interacting with features of the web site to locate information of a particular type, and the determined sequence of steps is automatically stored for later use.

Implementations may include one or more of the following features. An identification of a particular subject is received, and each step in the sequence of steps is automatically performed, including for at least one of the steps, retrieving from the web site information of the particular type related to the particular subject, and providing the retrieved information. An indication is received that the sequence of steps may be inaccurate, the web site is automatically interacted with to determine a new sequence of steps, the new sequence of steps is automatically determined to differ from the first sequence of steps, and the new sequence of steps is automatically stored. An identification of the website is automatically associated with the sequence of steps, and the sequence of steps is automatically stored in a database. A request for the sequence of steps is received, the sequence of steps is retrieved from the database, and the sequence of steps is provided. A second web site is automatically interacted with to determine a sequence of steps for interacting with features of the second web site to locate information of a second particular type, and the second determined sequence of steps is automatically stored for later use. The second web site is a separate website from the first web site.

In general, in one aspect, an identified website is automatically accessed, and one or more of following at least one link having a characteristic associated with a page where a product can be selected, and entering an identification of a first product in an input control of a page is performed to reach a web page providing access to particular information. a link to particular information about the first product is identified on the web page providing access to particular information. A list of the actions that led to the link to the particular information about the first product is returned.

Implementations may include one or more of the following features. Identifying the link to particular information about the first product includes following a link corresponding to the identification of the first product. Identifying the link to particular information about the first product includes selecting the identification of the first product from a menu. Identifying the link to particular information about the first product includes loading a linked page having links to information about the first product, and following each of the links. Identifying the link to particular information about the first product includes identifying a link to a terminal page having a target property. Identifying the link to particular information about the first product includes loading a linked page having links to portable documents.

In general, in one aspect, a sequence of steps that can be automatically followed to interact with features of a website to locate information of a particular type is received from a first tool, the sequence of steps is associated with an identification of the website, and the sequence of steps is stored in a database.

Implementations may include one or more of the following features. A request for the sequence of steps is received from a second tool, the sequence of steps is retrieved from the database and provided to the second tool. Receiving the request includes receiving an identification of a subject for which information of the particular type is sought. Receiving the request includes receiving an identification of a class of subjects for which information of the particular type is sought. Receiving the request includes receiving an identification of the web site receiving the request includes receiving an identification of an entity associated with the web site. An indication that the sequence of steps may be inaccurate is received, a revised sequence of steps is requested from the first tool, the revised sequence of steps is received from the first tool, and the set of steps is stored in the database. Receiving an indication that the set of steps may be inaccurate includes determining that information located using the sequence of steps is of poor quality.

In general, in one aspect, a first sequence of steps for locating information of a particular type on a particular web site is received from a first process, and the first sequence of steps is stored in a database of sequences of steps. Upon an identification of the particular web site as likely to provide information related to a particular subject, the first:sequence of steps is retrieved from the database and the first sequence of steps and an identification of the subject are provided to a second process. Information relating to the particular subject from the particular website is received from the second process. In some examples, the received information is provided to a source of a request for information related to the particular subject. In some examples, a website is generated displaying the received information.

In general, in one aspect, a sales listing offering an identified product is automatically identified, and stored information about the identified product is automatically located in a store of information about products. The stored information is associated with a sales listing for the product.

Other features and advantages of the invention will be apparent from the description and the claims.

### DESCRIPTION

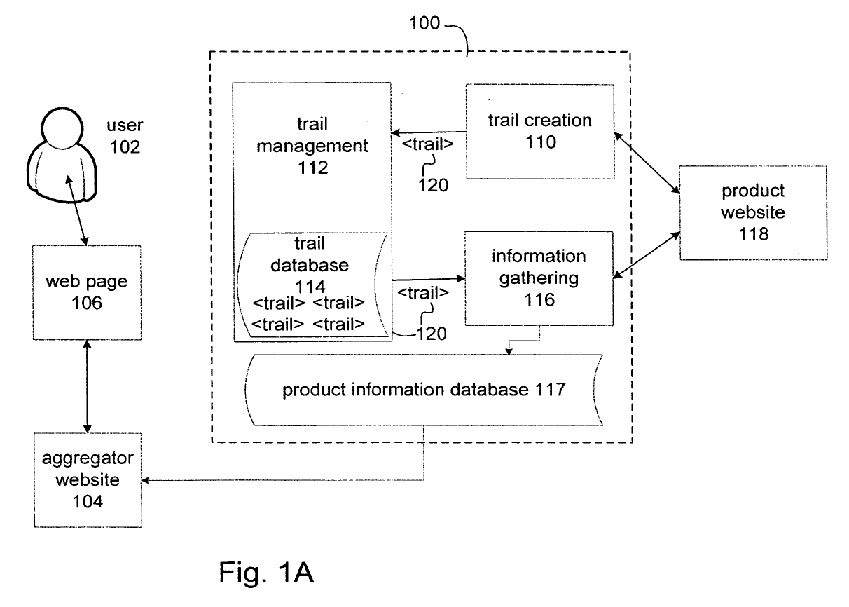

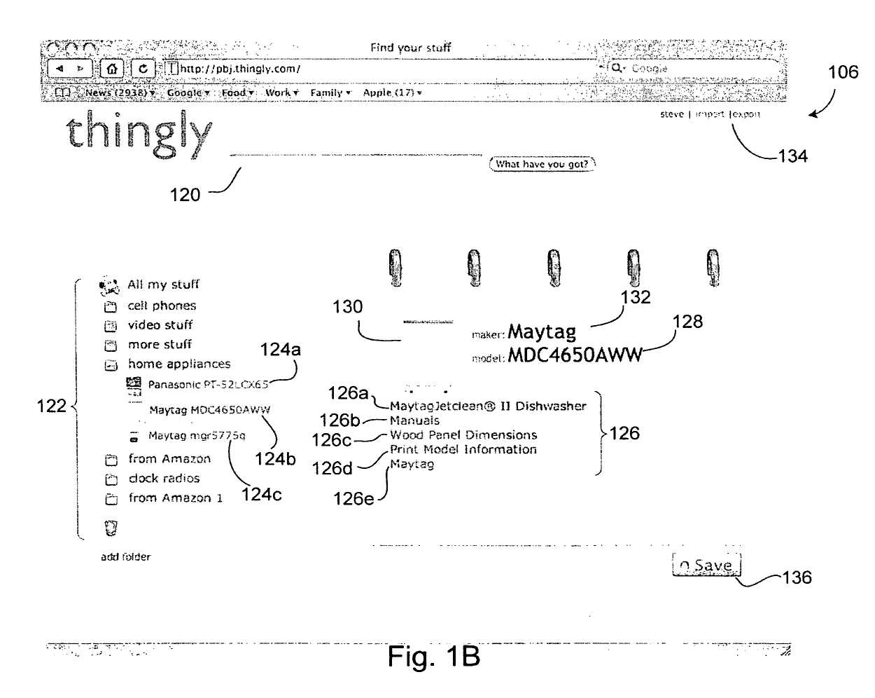

FIG. 1A shows a block diagrams.

FIGS. 1B, 2A-2K, 7, and 8 show websites.

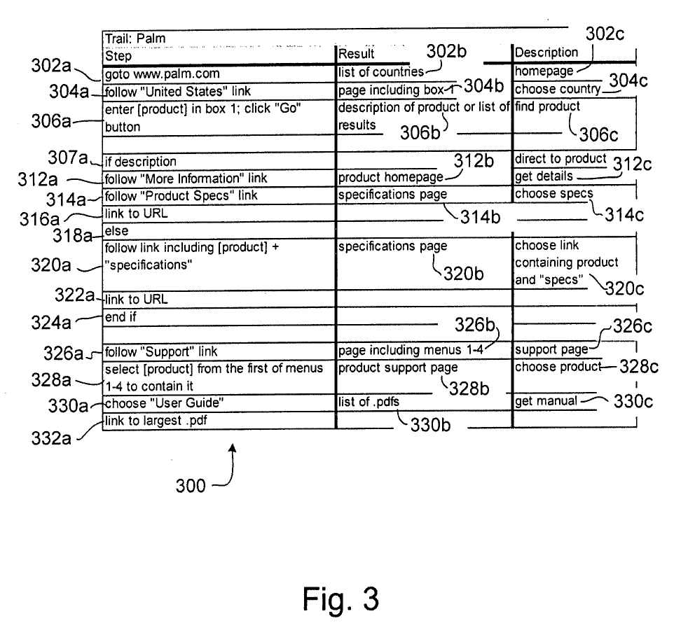

FIG. 3 shows a data structure.

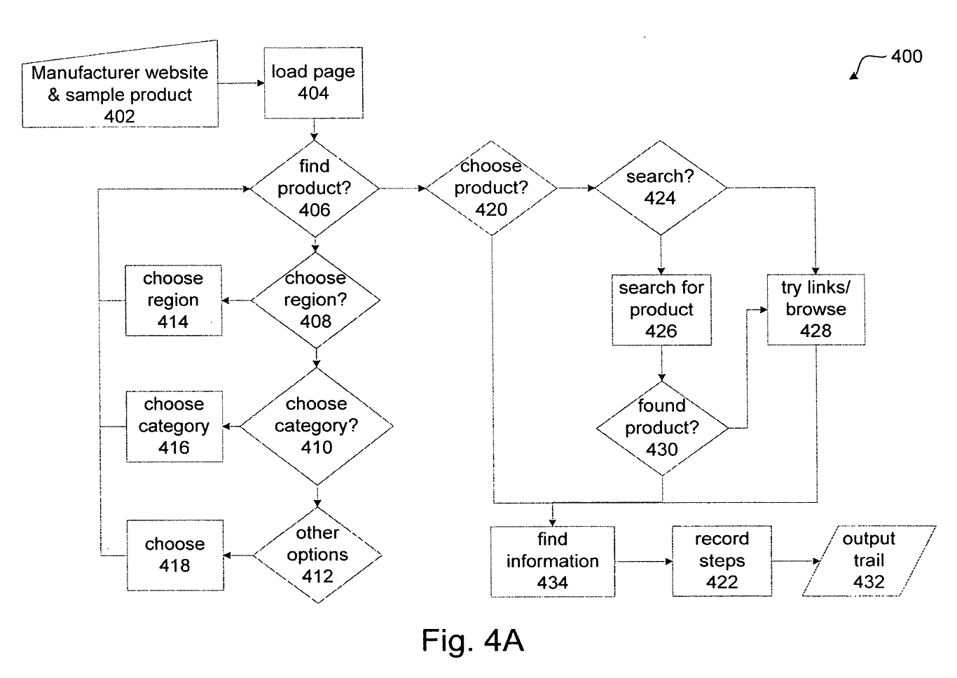

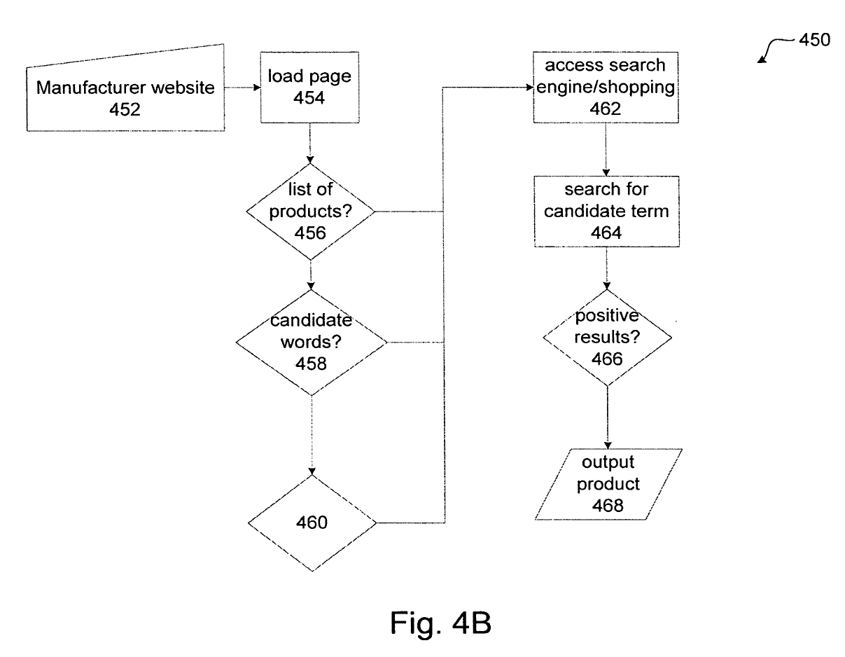

FIGS. 4A, 4B, 5, and 6 show flowcharts.

As described in U.S. patent application Ser. No. 11/400,128, filed Apr. 7, 2006, and incorporated here by reference, a variety of information about products can be aggregated on a single web site where owners or potential consumers of the products can easily and directly access the information in a single place. To facilitate this, as shown in FIG. 1A, a back-end system 100 collects and analyses product information and details about how to find that information. A user 102 interacts with an aggregator website 104 through a web page 106. The aggregator website 104 may be a special-purpose website dedicated to providing product information, a search engine, or a shopping site that stores information about its customer's purchase, to name a few examples.

An example of the web page 106 is shown in FIG. 1B. A search box 120 allows a user to search for products. A listing 122 shows products, e.g., 124a, 124b, 124c, that the user has previously found. Information 126 about the currently selected product 124b is displayed listed beneath an identification 128 and a picture 130 of the product and an identification 132 of the product's manufacturer. The information 126 in this example includes the brand name 126a of the product, manuals 126b, dimensions 126c, printed information 126d, and a link 126c to the manufacturer's home page. Import and export links 134 and a save button 136 are provided as discussed below. We refer to some types of information by reference to FIG. 1A, but the specific types of information shown are meant only as examples.

The back-end system 100 in FIG. 1A is based on a data structure that we refer to as a trail. As discussed in more detail below with reference to FIG. 3, a trail 120 describes how a particular type of product information 126, for example, manuals 126b for products 124i from a specific manufacturer 132, can be found. The term “product” includes any good or service of any kind, by way of a few examples, a tool, device, electronic gadget, appliance, or automobile.

In some examples, these products are durable, so that owners tend to need to refer to manuals or require occasional repair or maintenance. In some examples, identifiers of these products are standardized under a model name 126a or number 128, so that they can be referred to readily and consistently. Information 126 about products may include, but is not limited to, user manuals 126b, product specifications 126d, warranty documents, parts lists, device drivers and other software, information about accessories, recall information, and information about the secondary (resale) market for the product.

The back-end system 100 includes a trail creation tool 110, a trail management tool 112, a trail database 114, an information gathering tool 116, and a product information database 117. Each of these is described in more detail below. The trail creation tool 110 and information gathering tool 116 interact with websites that contain product information, e.g., a product website 118.

Some types of user interaction with web pages that leads to useful information is not captured by web crawlers of the kind that merely follow every hypertext link on a page. For example, typical web crawlers do not use search boxes because they do not have specific terms to search for. It may be possible to directly access product information on a manufacturer's website by searching for the product number, but following links will only lead to that information, if at all, through a string of intermediate pages. As described below, using search boxes and similar interactive web site features and recording which types of interactions lead to desired information allows an advanced web crawler to build a trail of where that information can be found.

Searching for information by emulating steps a human would take to navigate to a desired page can be more efficient and more effective for extracting specific information than merely following every link through a webpage. For example, suppose a user wanted to extract specifications for a specific cell phone from its manufacturer's web site. A typical web crawler would start at the manufacturer's top level page and follow every link on that page, building a database of every page that website offers, only a small portion of which relate to product specifications. From these pages, a search engine indexes certain pages as matching a pattern indicating that they describe the specific cell phone. Within those pages, another pattern is matched to find product specifications. The resulting information is extracted, cleaned up, and returned.

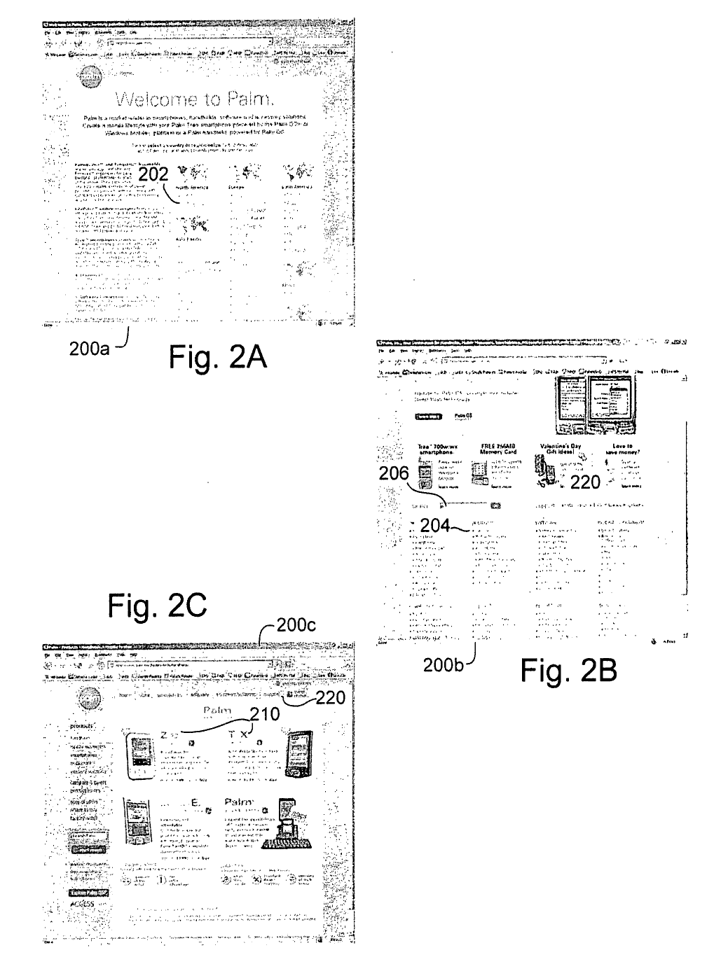

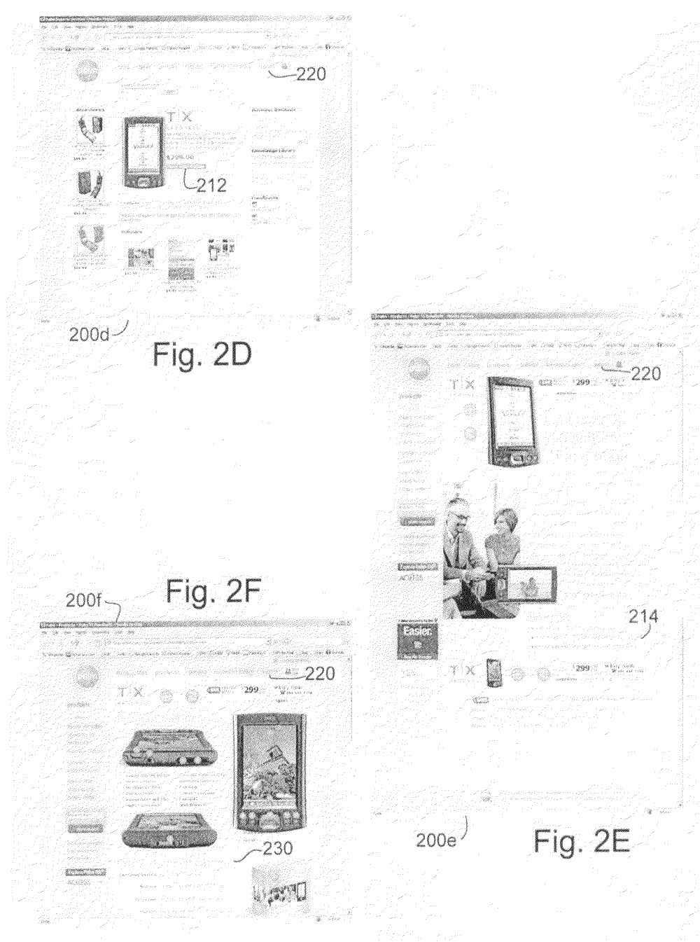

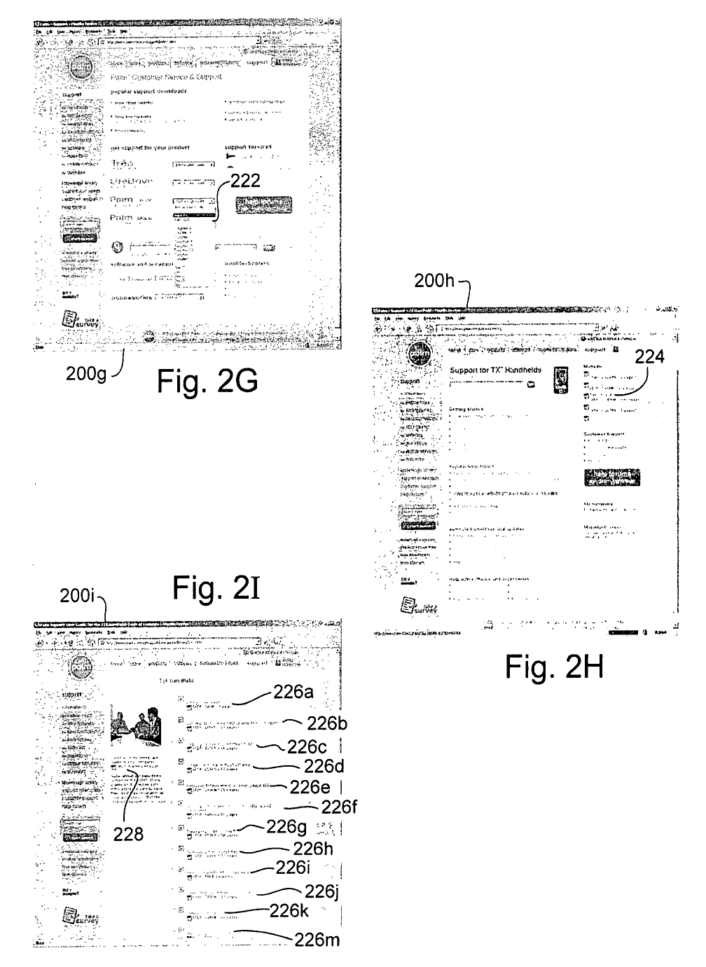

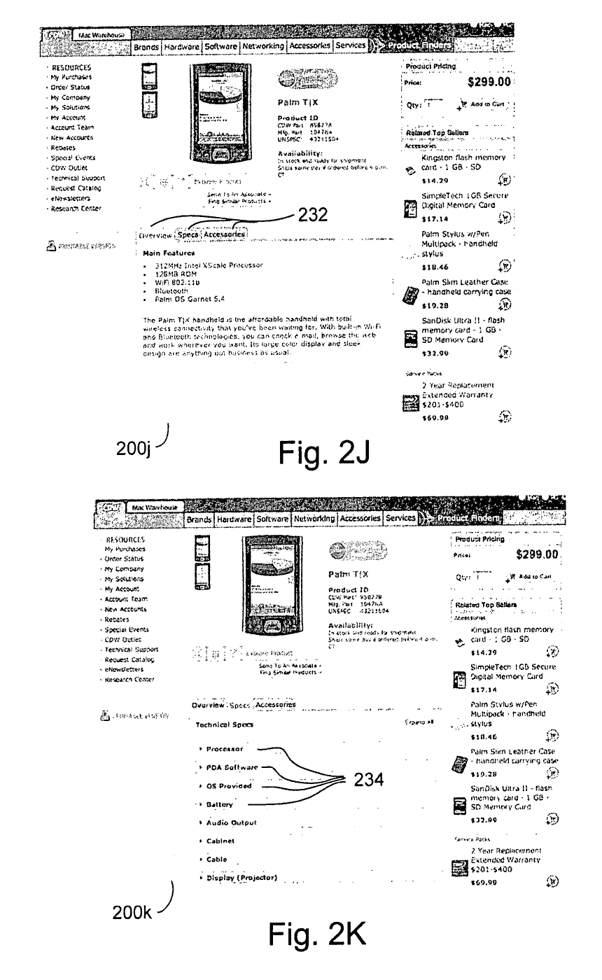

The trail creation tool 110 builds a trail 120 by interacting with a web site 118 in a way that is the same as or at least more similar to the way that the site's authors intended for humans to use it. For example, as shown in FIGS. 2A-2K, to find information about a Palm T|X handheld device, a human could access Palm's top-level web page 200a (FIG. 2A). Instead of clicking on every link there, however, the user will typically select a country, e.g., “United States” 202, after watching or bypassing any advertising that the web site presents before offering links. The user next may select a product line, e.g., the “handhelds” link 204 on a country-level web page 200b in FIG. 2B. For some websites, the product line maybe the first selection. Selecting a product line may consist of clicking on a link, as in FIG. 2B, or choosing it from a menu, and may first require that the user indicate, again through a link or menu, that he is interested in products, as opposed to, for example, investment opportunities or employment. In some examples, the user is asked to select an area of interest before selecting a country or region.

At some point, depending on the size of the company's product line, the user may need to search for his specific product model. He may do this using a search box 206, a drop-down menu (not shown), or a sequence of links 204, 210 (FIGS. 2B, 2C), depending on the design of the website. In the example of FIGS. 2A-2F, the user can search right away (box 206 on page 200b in FIG. 2B) or may select which product line he is interested in, then the specific model. In the case of Palm, clicking the “handhelds” link 204 leads to a page 200c, in FIG. 2C, where the user can select one of the three current models, e.g., “Palm T|X” link 210, while searching through box 206 leads directly to the searched-for model, as shown a results page 200d in FIG. 2D. Clicking either the model 210 in FIG. 2C or the “More Information” link 212 in FIG. 2D takes the user to the product page 202e, shown in FIG. 2E.

Once the user has found a desired product, reaching the specifications may include such interactions as following a link, such as the “product specs” link 214 in FIG. 2E, or selecting from a menu (e.g., menu 222 in FIG. 2G). Specifications 230 may be in a single web page (e.g., page 200f in FIG. 2F), a collection of tabs 232 on one page 200j (FIG. 2J), a collection of links 234 to other pages (e.g., page 200k in FIG. 2K), or links 226 to one or more PDF documents (e.g., page 200i in FIG. 2I). In some examples, product information that the manufacturer thinks is more useful to owners than to potential customers is only available in a support section rather than in a product section. As shown in FIG. 2G-i, selecting a “support” link 220 in any of the several pages 200b-200f takes a user to the support page 200g, in FIG. 2G, where he can select a model from a menu 222. This takes the user to a page 200h, in FIG. 2H, where the user can select various sources of information, such as “User Guides,” link 224. This in turn takes the user to a page 200i, in FIG. 2I, offering several .pdf files 226 for download. In this example, one of the files 228 is the entire users guide, containing all of the other files 226a-m.

To build a trail that will allow a system to rapidly find all the information about a product, the trail creation tool mimics human user behavior to discover how to find relevant product information on, for example, a given manufacturer's web page. Instead of building a database with entries like “Palm T|X specifications are at http://www.palm.com/us/products/handhelds/tx/specs.p1; Palm T|X manual is at http://www.palm.com/us/support/handbooks/tx/en/tx_ug.pdf,” by clicking on every link at www.palm.com and indexing what they lead to, the trail creation tool records the steps it followed to get to those pages in a way that can be reused for other products. For the same example, the trail might instruct: “for Palm products, go to www.palm.com, click <United States>, put the product name in the search box, click <go>, click <more information>, click <product specs>; also click <support>, select the product name from whichever of menus 1-4 contains it, click <User Guide>, download the largest .pdf file offered.” Because Palm provides information about all their products the same way from the user's point of view, these instructions will work for any of their products, while a generic listing of how to build the URL may not work, as the URLs depend on what category Palm has internally sorted the product into and what abbreviation Pam uses for the product. The trail might also contain alternatives, for example, “if the search produces a list rather than a product page, scan the list for an entry with the product name and ‘specifications’ in it.” With such instructions, the information gathering tool can find information for a new product without a crawler having to have first come across that product while exploring all the links on the web.

In some examples, building and using trails can be done by the components shown in FIG. 1A: a trail data structure for efficiently describing the trails 120, the trail creation tool 110 to automatically create and improve the trails 120, the information gathering tool 116 to return to web sites 118, extract the desired information based on the trails 120, and store it in the product information database 117, and the trail management tool 112 to automatically store, manage, and maintain the trails 120 in the trail database 114.

### Trail Data Structure

A trail 120 describes how to navigate through a web site and what information one can expect to find there. We refer to the elements of a trail as steps and results. As shown in FIG. 3, steps 302a-332a in the left column record the process described above for finding product information on the Palm website. Results 302b-330b in the center column indicate what is produced by each corresponding step. Descriptions 302c-330c in the right column explain the semantic meaning of the corresponding step, as described below.

Steps correspond to actions taken to navigate on a web site and results describe the states of the pages in response those actions. Examples of typical steps include following a link, selecting an item from a menu, entering text in a form input box, choosing a checkbox or radio button in a form, clicking a “submit” button on a form, rolling the mouse over a certain place on a page, and clicking on a button inside a flash animation. The steps of a trail could be any steps that a human might perform on a web page.

Examples of results include a page including a search box, a page listing many results, a listing of results spanning multiple pages (often containing a “next” link at the bottom), a pull-down list containing choices, and files available for download. In some examples the results are implicit in subsequent steps and are not stored as discreet components of the trail. For example, in step 306a, the command “enter [product] in box 1” implies that he results 304b of step 304a included a search box 1.

Most steps have semantic meaning, that is, a description or semantic tag that is intuitive to the human creators and users of a web site. The meaning can be represented by a simple string such as “choose country” or “choose a link including ‘specs’” that is associated with a step. By attaching a semantic tag to a step, the purpose of the step can be more clear to a human attempting to guide, inspect, or debug the step. (Depending on the programming language used to encode trails, the steps may not be as human-readable as in the example of FIG. 3. In some examples, the programming language may render separately storing semantic descriptions unnecessary) In some examples, semantic tags may be incorporated into the step or attached as comments.

A semantic tag can also be used to guide the answer to a choice presented by a step. For example, if the step is known to be a “choose country” step, and the user is interested in information for the USA, the information gathering tool using the trail can automatically choose an option containing a string such as “United States,” “US,” or “USA,” with or without periods. The software may also be configured to first select “North America” or “Americas” if it does not see some form of United States as an option. Alternatively, the trail may include a step of “choose region” prior to the step of “choose country.”

### Creating and Improving Trails

It is useful for the tool to be able to extract information from a large number of sites (hundreds, thousands, or perhaps even millions of sites). In some examples, the body of sites visited would include all the manufacturers and the largest retailers of products likely to be searched by its users. To facilitate this, these trails should be generated automatically, or at least semi-automatically (i.e., mostly automated, but involving some human assistance).Hoste.d websites typically do not have identical structures. Thus, a trail that works for one manufacturer is unlikely to work for another.

As was shown in FIGS. 2A-2K, the structures of many company web sites share common features. Typically, such a site includes a home page 200a for the company, an introductory “splash” animation or pages (not shown), a region selection 202 (e.g., which country the user is in), a business unit selection 220 (e.g., Honda vs. Acura at Honda's website), a product category selection 204 (e.g., cameras vs. copiers at Canon's website), a functional area to visit, such as a “products” home page 200c in which to start browsing products or a “support” home page 200g in which to get support information, and there may be a text input box 204, typically a “search” box, in which a user types a search term, such as the name of a product (when looking for product information), or the name of a city (when looking for a retailer), etc. In some cases, there are multiple input boxes, for example, one to search for products, one to search for retail locations, and one to provide contact information.

The trail creation tool explores sites by starting with the home page and trying the above possible features in various combinations until it arrives at a result meeting its criteria. The tool may be seeded with actual names of products so that it has something to provide as input for search boxes or product selection menus, or it may use additional heuristics to discover product names, as described below. When the result is achieved and product information is located, the specific combination of website features used to get there is recorded and stored as a trail.

In some examples of an algorithm for the trail creation tool, shown in FIG. 4A, the tool receives (402) an identification of the target website, such as its URL, and, in some examples, a sample product name (which may be the output of another process 450, FIG. 4B) and proceeds to load (404) the web page. The tool looks (406) for a website feature with which to choose a product. The feature may be, for example, a menu that lets the tool choose (420) a product or it may be a search box (424). Because websites often ask a user to choose a location or business unit before they can choose a product, if the tool cannot input the product on the first page, the tool determines whether the page appears to be asking for a location (408), for example, by presenting a map or a list of regions or countries, or whether it appears to be presenting choices using terms like “business,” “products,” “investment,” “careers,” or “Support” that may represent categories or more-specialized web pages (410). There may be other options (412) as well, and the tool follows (414, 416, 418) the appropriate links, as needed, until it reaches a page that appears to have a list of products, a list of types of products (using heuristics to identify such a list, for example, as described in the above-mentioned patent application's knowledge engine), or a search box.

If the tool can directly choose a product (420), it will note to do so (422), that is, it will record that interaction as one of the steps to find the product information. If it finds one or more search boxes (424), the tool will enter a sample product name in each box (426) to see what kinds of results it gets. If the tool was not given a sample product name, it may discover one at this point by applying the process 450 in FIG. 4B. A sample product name may not be needed if, for example, a menu is called “products.” If any of the results appear to be product information (430) it records that search box as the step to use (422). Alternatively, the tool may follow (428) the links that were returned until it finds which one is actually the product information (as opposed to, e.g., press releases about the product). If there was no search box, the tool may try other links, for example browsing through a directory of product lines.

Once the tool has found what appears to be a homepage for a product (420, 428, or 430), it uses other heuristics (434) about the relevance of links to determine which links will deliver the information it wants. Some links will have useful titles, like “specifications,” “details,” “user's guide,” or “downloads.” Other links may not be as clear or may appear irrelevant, and the tool may pass over these, at least until it determines that the more promising links were not what it wanted. The tool determines whether the links it found lead directly to the desired information or to an intermediate page, and records the steps that must be followed to reach the information. The final step in the trail indicates the link that leads to the page that contains the product information. The information gathering tool will later use such a link to retrieve the information so that it can be provided to the user. Whatever path eventually leads to the product information, the tool records the necessary steps (422) and returns these as the trail (432).

The trail creation tool may rely, at least in part, on the organizational logic behind a website to identify what information is important. To list a few examples, a page with a large picture and multiple links with titles like “specifications” and “details” is probably the main page for a product, and several of the links there may lead to product information. A page with many pictures of similar size or many drop-down menus may be presenting multiple products from which the user can choose. A page that has many links to .pdf documents may be a source of user manuals and other useful information.

As noted above, heuristics may be used to discover product names. An example of such a process is shown in FIG. 4B. In some examples, as shown in process 450, the tool may try several methods to discover product names. The process 450 begins by receiving (452) and loading (454) a manufacturer's web page (possibly navigating to an appropriate starting point as described above). When the manufacturer's web page is structured in such a way that a list of products is provided (456), for example, in a pull-down menu near a tag like “select a product” or “products,” the contents of that menu can be assumed to be product names. The tool may analyze (458) the text of several pages on the manufacturer's site for likely product names. Product names tend to be mentioned in the title of a web page (e.g., inside <title> or <h1> tags). Product names also tend to be low-frequency words (i.e., words that are not commonly used in texts that are not describing the subject matter of those words) or words that do not appear in English dictionaries (or any other relevant language) but appear with relatively high frequency on the manufacturer's web site. Other techniques may also be used (460) until suitable candidate terms are found.

Once candidate terms have been found, the process 450 may verify that these are product names by entering them (464) as search terms in secondary sources 462, such as a product-focused search engine such as Google Product Search or an appropriate shopping site, such as Amazon.com. If one of these sites returns appropriate results (466) (e.g., a large number of links from Google Product Search or a product page from Amazon.com), the process can assume that the candidate term is the name of a real product and output (468) the term. Such secondary sites may also be used to discover product names, for example, by entering the manufacturer's name as a search term in Amazon.com, and assuming the titles of the returned pages are that manufacturer's products, verified by locating pages containing the same terms on the manufacturer's site. The product name identification process 450 may be integrated into the trail creation tool or may be provided by a separate module. It maybe carried out as a discrete step or may be implemented as part of various steps of the main process 400.

Starting points for the trail creation tool may include the URL of a home page for a company and a pattern describing the target information the trail seeks to find. For example, suppose the operator wanted the tool to crawl sites belonging to 1,000 product manufacturers and extract the manuals for their products. The operator would provide the tool a list of 1,000 URLs corresponding to the desired manufacturers, and a pattern matching user manuals. The pattern could describe a link to downloadable Acrobat (PDF) files, (i.e., a URL ending in “.pdf,”) where the link or the file name contains “manual” or “guide.” For each site, the tool applies the algorithm of FIG. 4A, trying the possible elements in combinations until a matching pattern is found yielding a product manual. In some examples, the company home pages and product descriptions are provided to the trail creation tool by the crawler or knowledge module described in the above-referenced patent application. That knowledge module may include detailed information about how to identify products and to differentiate them from other things found on websites that do not ultimately lead to product information. Similar processes could also be used to generate the initial list of manufacturer or other starting-point URLs.

Such a semi-automated tool may also allow the operator to provide direct input into the process as it progresses to guide or approve the pattern-matching process. For example, the system may present a series of candidate pages to the operator. The operator simply decides “yes” or “no” as to whether the candidate page contains the manuals being sought. This requires human labor, but may be a more efficient use of that labor than a fully manual system.

The mechanism for creating trails can also be used to maintain and improve them. Over time, web sites change, and the trails need to be periodically tested and, if necessary, updated to reflect these changes. The tool can be re-run periodically from the same starting point to identify any changes in how each web site is structured and provide updates to the trail. How often a trail is refreshed may be determined according to a fixed schedule or may be based on previous search results. For example, if the trail for a particular manufacturer is found to be different each time the tool attempts to verify it, the frequency at which that trail is verified and updated may be increased. In some examples, the trail is updated because it no longer produces good results. Results may be considered poor if, for example, they resemble press releases rather than user manuals. Various heuristics may be used to differentiate good results from poor results. Good results may be .pdf files, files with product names in their filenames, and files with terms like “operating manual” in their file names. Poor results might be plain text and have key words in their body but not their title. Poor results may also be relative to earlier results. For example, if the last time a trail was run, five good files were found, and this time, a relatively empty page, the trail needs to be updated.

Over time, the needs or objectives of the information gathering tool may change, and more information from each web site might need to be extracted. For example, if the operator of the aggregating website wishes to add driver downloads to the product information he aggregates, doing so may require different trails than arc used to find product manuals. In such a case, additional trails describing alternative paths through each might need to be created. The trail creation tool can be run using a new target pattern matching downloadable driver files to build these new trails. Trails may also be improved through the use of the learning module described in the above-referenced patent application.

In some examples, the trail creation tool may be used to build trails for a wide variety of websites other than those of manufacturers. For example, some websites, such as archive.org, archive the contents of other websites. The trail creation tool may be instructed to build trails to information on such an archive in order to allow users to find information about older or obsolete products that may no longer be available on their manufacturer's websites, or for which the manufacturers are no longer in business. In some examples, customers of a product may have accumulated more information or more useful information than the manufacturer provides, and the trail creation tool may be used to build trails to find the information in the customers' websites. Sites maintained by retailers or wholesalers or vendors may also contain information of the kind being sought. Sites operated by product reviewers may also be usefully crawled.

Another advantage of trails is that they may facilitate the normalization of information. That is, the information available for different products often differs greatly. A uniform set of trails that lead other tools to that information may allow the tools to present the information to the users in a more uniform manner than is done even by tie manufacturers themselves. For example, one manufacturer may include specifications and installation instructions on a webpage intended for presenting their product to prospective customers, while driver downloads and user's manuals are found at a webpage intended for supporting existing customers. Another manufacturer may put all this information at one or the other or both locations. The information gathering tool, described next, will find this information through the trails and can present it in a single location for each product, relieving the user of figuring out where a given manufacturer has chosen to put a given type of information.

In some examples, manufacturers could choose to provide trails themselves. This could be done through an XML feed or any other open or proprietary format. Providing trails themselves could allow manufacturers to control which information the trail leads to, for example, a manufacturer may prefer that the information gathering tool download files from a dedicated server that provides fast connections but is not user-friendly, while their main website is designed to provide a good visual experience for human users but cannot handle the load of numerous downloads.

### Information Gathering Tool

Once a trail has been created, it can be used to guide the information gathering tool to retrieve specific information that it seeks. For example, a trail for Nokia may represent the following steps:
1. visit Nokia.com
2. identify your home country—respond “United States”
3. watch a brief commercial for a recent model phone
4. find a menu presenting several options—choose “phones”
5. choose the phone model desired
6. choose “view specifications”
7. read the specifications

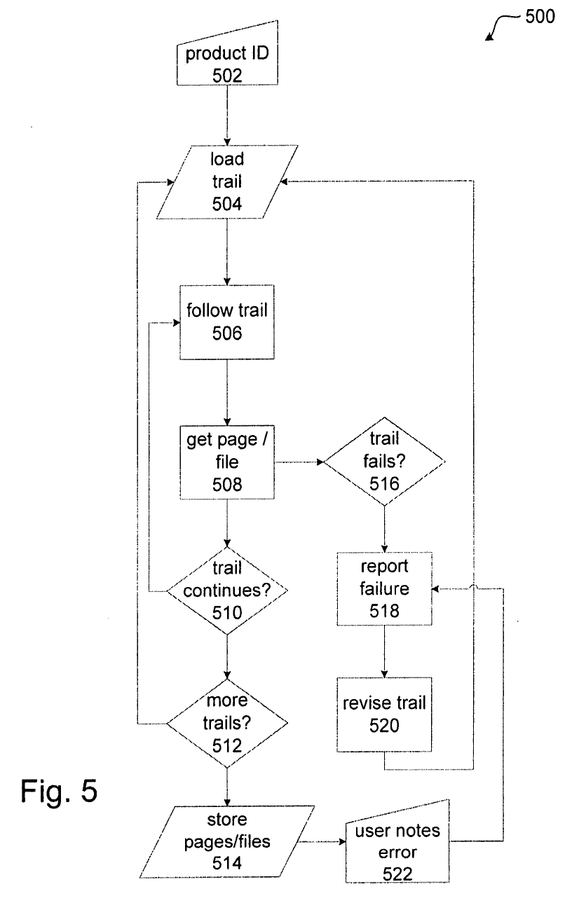

Properly programmed to use the trail data structure, an automated process can follow these steps and deliver the specifications as requested. An example algorithm is shown in FIG. 5. The information gathering tool receives (502) information identifying die product, such as a model number or product name. In some examples, the information gathering tool 116 is used to populate the database 117 independently of any user directly requesting information, so the product name discovery process 450 is used to find all the products of a given manufacturer, rather than starting with a product ID 502. The product identification may directly indicate what trail to load (e.g., if it includes the manufacturer's name), or another system, such as the knowledge engine of the above-referenced patent application, may provide information about who manufactures the product and which trail should be used. The information gathering tool then loads (504) the trail and follows it (506) using the product identification. When the trail leads it to a product information page or downloadable file, the tool retrieves that (508). If the trail continues (510), for example, because there are multiple useful pages at that site, the tool continues to follow it (506) and retrieve pages or files (508). In some examples, there may be multiple trails (512), for example, if some product information is found at a marketing site and some is found at a support site. In this event, the tool loads the next trail (504) and repeats the process. Once all the trails have been followed to completion, all the retrieved pages and files are stored (514) in the product information database. In some examples, the process 500 is carried out in response to a user request, so the pages and files arc delivered directly to the user.

If the information gathering tool follows a trail and fails (516) to find the desired information, it may feed this back (518) to the trail creation tool, triggering that tool to revisit the manufacturer's website and revise the trail (520), after which the information gathering tool repeats the process 500. When the information gathering tool is run in response to a user request, rather than to update the database 117, it may wait for the revised trail, or it may inform the user that the information cannot be found and to try again later. The operator of the aggregating web site may also trigger the revision process 522, and they may allow end users to suggest that it be done, for example by providing a clickable “this isn't relevant” input with the retrieved information.

The information gathering tool may be an element of the query engine described in the above-referenced patent application. In some examples, the information collected by the information gathering tool is stored in the product information database 117 to provide immediate access to the information. The database 117 may be updated according to a fixed schedule or dynamically, for example, in response to how often a particular product is searched for or based on information about how often a manufacturer updates its information. Once populated, the database 117 serves as an encyclopedia of product information. Whenever a user needs information about a product, it can be found in the database 117. If a user requests information that is not already in the database, the above process 500 can be used to get the information on demand for that user, and store it to the database 117 for the next time it is needed by the same or another user.

### Trail Management Tool

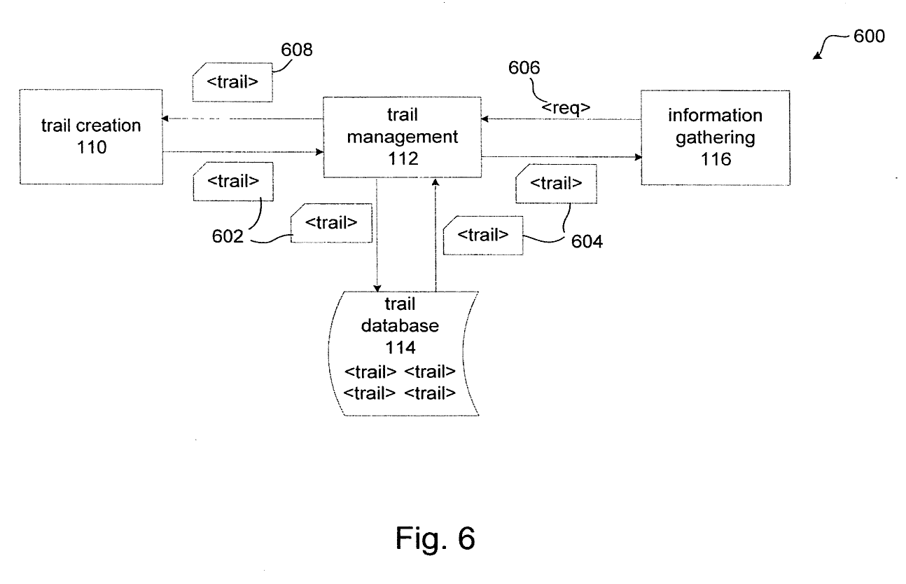

The trail management tool is a storage system that receives the trails as they are generated or updated by the trail creation tool and provides them as needed to the information gathering tool, as shown in FIG. 6. The trail creation tool 110 generates new trails 602 as described above and delivers them to the trail management tool 112. The trail management tool adds the new trail 602 to the trail database 114. When the information gathering tool 116 needs a trail 604, it requests it (606) from the trail management tool 112. The trail management tool 112 retrieves the requested trail 604 from the database 114 and provides it to the information gathering tool 116. When a trail 608 needs to be updated, the trail management tool reports this to the trail creation tool 110 and may provide a copy of the present version of the trail.

In some examples, the trails stored in the database are indexed with additional information that makes them easy to retrieve. For example, they can be indexed by the name of the company they describe and which kinds of products they relate to as well as which kind of information they lead to.

In some examples, the trail management tool 112 marks the trails in the database 114 with additional information for maintenance purposes, such as the date when a trail was last used, the date when a trail was last tested for validity, and a flag indicating whether the last validity test was successful or unsuccessful (implying that an update is required).

### Importing Data

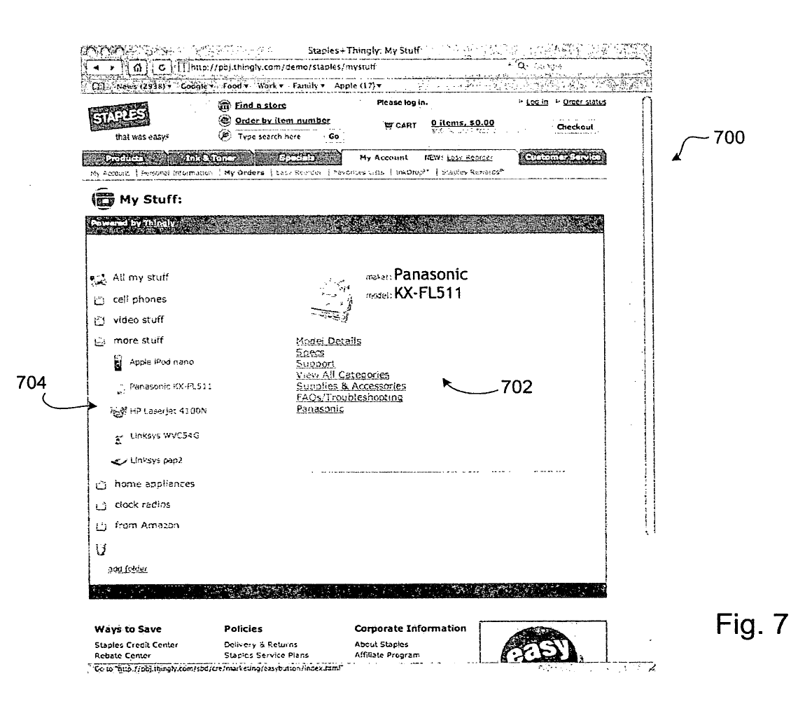

Any of the data used in the processes above may be provided by partner websites, rather than input to or collected by the aggregator website. For example, a retail website that sells consumer goods might inform the aggregator website about purchases made by users who have registered with both sites. The aggregator website can associate the purchase with the user and gather the related product information and make the information available to the user automatically. As shown in FIG. 7, the aggregator website may also be integrated into the retail website 700, so that the retail website's users have direct access to product information 702 about products 704 they purchased (at that website or elsewhere) without having to load a separate web site (e.g., the dedicated aggregator site 106 in FIG. 1B). In some examples, the user provides the aggregator website with his user name and password at the retail website, and the aggregator website obtains information about a user's purchases from the retail website without any change required on the part of the retail website. The aggregator system might include a trail for finding both purchase history and information about purchased products from specific retail websites.

### Outputting Product Data

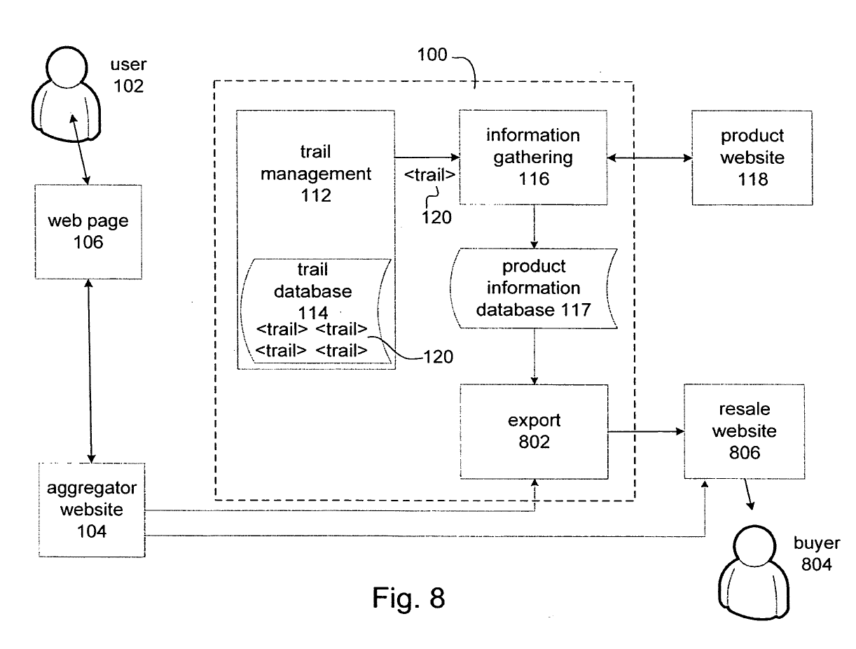

In some examples, a user may wish to sell a product he has acquired. Providing the sort of information gathered by the information gathering tool to potential buyers may enhance the desirability of the product, allowing the user to sell it faster or at a higher price. As shown in FIG. 8, an export tool 802 may be provided that exports the information gathered by the information gathering tool 16, either directly or as a set of links, in a format that is conveniently transferred to the buyer 804 or posted to a website 806 through which the user 102 is selling the product. For example, if the user is using eBay to auction his product, the product information gathered by the tool can be used to create a data feed into a module on the eBay auction page for the product. When the user tells eBay that he wants the sell the product, eBay can offer to provide the module. In some cases, the aggregator charges eBay for providing the information, and eBay may absorb this as a cost of doing business or may pass it on to the seller as an upgrade to the basic auction. Various pricing models exist, such as per-auction or per-page load.

In some examples, the product information is packaged and provided to third party sites that provide the service of constructing a sale or auction page and uploading it to sites like Craigslist or eBay automatically, even presenting the user with a suggested opening bid or target price, if the information gathering tool 116 has gathered relevant information. This service may also be provided directly to the seller by the aggregator website. The user 102 can continue to interact through web pages 106 provided by the aggregator site 104 and create and manage his sale via links between the aggregator website 104 and the resale website 806.

Product information could also be exported to asset management software, for example, a personal financial manager for home use or an enterprise-level database used by a corporation's office manager to track corporate property. Product data could also be provided through a retailer's website, for example, if a retailer maintains a record of its customer's purchases, the customers could return to the retailer's website to find product information provided by the described system. This could relieve the retailer of having to collect and manage that information from its: vendors. In some examples, a system hosting the tool can be given a user's identification and passwords for retailers' websites and may use that information to find all the products that user has bought from those retailers. The system can then locate all the relevant product information and provide it to the user without the user having to input and search for each of his purchases by hand.

In some examples, the system provides the product information as a feed, such as an RSS feed. Feeds may, for example, be freely provided or may be offered oil a paid subscription basis.

Other implementations are within the scope of the following claims and other claims.

What is claimed is:

1. A method comprising, on a computer:
automatically identifying a web site likely to provide information related to an identified subject; and
automatically following a stored sequence of steps to interact with features of the website to locate information of a particular type related to the identified subject, including for at least one of the steps retrieving the information.

2. The method of claim 1 also comprising, on the computer:
automatically storing the retrieved information.

3. The method of claim 1 also comprising, on the computer:
providing the retrieved information.

4. The method of claim 1 also comprising, on the computer:
generating a web page displaying the retrieved information.

5. The method of claim 1 in which the particular type of information comprises information about products.

6. The method of claim 5 in which the information about products comprises one or more of user manuals, specifications, software, prices, accessories, support information, and updates.

7. The method of claim 1 in which the identified subject comprises a type or family of products.

8. The method of claim 1 also comprising, on the computer:
generating an identification of a product to use as the identified subject.

9. The method of claim 8 in which generating the identification of the product comprises:
loading a web page associated with a manufacturer of products;
if the web page does not include a list of products,
selecting a word on the web page likely to be product names;
searching for the selected word in a search engine;
if the search engine returns web pages appearing to contain product information, using the selected word as the identification of the product.

10. The method of claim 9 in which a word is likely to be a product name if frequency of the word on the web page is greater than the frequency of the word in common usage.

11. The method of claim 9 in which a word is likely to be a product name if the word does not appear in a dictionary of the language used on the web page.

12. The method of claim 1 in which the identified subject comprises an identification of a product.

13. The method of claim 12 in which the identification of the product comprises one or more or a combination of a product ID number, a trademark, a brand name, a manufacturer, a common name, or a UPC code number.

14. The method of claim 1 in which the web site comprises one or more of a search engine, a manufacturer's website, a retailer's website, or a data aggregating web site.

15. The method of claim 1 also comprising, on the computer:
automatically identifying a second web site likely to provide information related to the identified subject; and
automatically following a second stored sequence of steps to interact with features of the second website to locate information of a second particular type related to the identified subject, including for at least one of the steps retrieving the information.

16. The method of claim 15 in which the second web site is a separate website from the first web site.

17. The method of claim 1 in which automatically identifying the web site comprises:
using an internet search engine to search for sites related to the identified subject; and
identifying a result of the search for which a sequence of steps is available.

18. A method comprising, on a computer:
automatically interacting with a web site to determine a sequence of steps for interacting with features of the web site to locate information of a particular type; and
automatically storing, for later use, the determined sequence of steps.

19. The method of claim 18 also comprising, on the computer:
receiving an identification of a particular subject; and
automatically
performing each step in the sequence of steps, including for at least one of the steps, retrieving from the web site information of the particular type related to the particular subject, and
providing the retrieved information.

20. The method of claim 18 also comprising, on the computer:
receiving an indication that the sequence of steps may be inaccurate;
automatically interacting with the web site to determine a new sequence of steps;
automatically determining that the new sequence of steps differs from the first sequence of steps; and
automatically storing the new sequence of steps.

21. The method of claim 18 also comprising, on the computer:
automatically associating with the sequence of steps an identification of the website; and
automatically storing the sequence of steps in a database.

22. The method of claim 21 also comprising, on the computer:
receiving a request for the sequence of steps;
retrieving the sequence of steps from the database; and
providing the sequence of steps.

23. The method of claim 18 also comprising, on the computer:
automatically interacting with a second web site to determine a sequence of steps for interacting with features of the second web site to locate information of a second particular type; and
automatically storing, for later use, the second determined sequence of steps.

24. The method of claim 23 in which the second web site is a separate website from the first web site.

25. A method comprising, on a computer:
automatically
accessing an identified website;
performing one or more of the following actions to reach a web page providing access to particular information:
following at least one link having a characteristic associated with a page where a product can be selected, and
entering an identification of a first product in an input control of a page;
identifying a link to particular information about the first product on the web page providing access to the particular information; and
returning a list of the actions that led to the link to the particular information about the first product.

26. The method of claim 25 in which identifying the link to particular information about the first product comprises, on the computer:
following a link corresponding to the identification of the first product.

27. The method of claim 25 in which identifying the link to particular information about the first product comprises, on the computer:
selecting the identification of the first product from a menu.

28. The method of claim 25 in which identifying the link to particular information about the first product comprises, on the computer, on the computer:
loading a linked page having links to information about the first product, and following each of the links.

29. The method of claim 25 in which identifying the link to particular information about the first product comprises, on the computer:
identifying a link to a terminal page having a target property.

30. The method of claim 25 in which identifying the link to particular information about the first product comprises, on the computer:
loading a linked page having links to portable documents.

31. A method comprising, on a computer:
receiving from a first tool a sequence of steps that can be automatically followed to interact with features of a website to locate information of a particular type;
associating with the sequence of steps an identification of the website; and
storing the sequence of steps in a database.

32. The method of claim 31 also comprising, on the computer:
receiving from a second tool a request for the sequence of steps;
retrieving the sequence of steps from the database; and
providing the sequence of steps to the second tool.

33. The method of claim 32 in which receiving the request comprises receiving an identification of a subject for which information of the particular type is sought.

34. The method of claim 32 in which receiving the request comprises receiving an identification of a class of subjects for which information of the particular type is sought.

35. The method of claim 32 in which receiving the request comprises receiving an identification of the web site.

36. The method of claim 32 in which receiving the request comprises receiving an identification of an entity associated with the web site.

37. The method of claim 31 also compromising:
receiving an indication that the sequence of steps may be inaccurate;
requesting a revised sequence of steps from the first tool;
receiving the revised sequence of steps from the first tool; and
storing the sequence of steps in the database.

38. The method of claim 37 in which receiving an indication that the sequence of steps may be inaccurate comprises determining that information located using the sequence of steps is of poor quality.

39. A method comprising, on a computer:
receiving from a first process a sequence of steps for locating information of a particular type on a particular web site;
storing the sequence of steps in a database of sequences of steps; and
upon identifying the particular web site as likely to provide information related to a particular subject,
retrieving the sequence of steps from the database,
providing the sequence of steps and an identification of the subject to a second process, and
receiving from the second process information relating to the particular subject from the particular website.

40. The method of claim 39 also comprising, on the computer:
providing the received information to a source of a request for information related to the particular subject.

41. The method of claim 39 also comprising, on the computer:
generating a web page displaying the received information.

42. The method of claim 5 also comprising, on the computer:
automatically storing the retrieved information, and
at a time later than the storing, automatically associating the stored information with a sales listing for an identified product.

43. The method of claim 42 in which associating the stored information comprises, on the computer:
in communication with a second website,
automatically identifying a sales listing offering the identified product; and
automatically adding the stored information to the sales listing.

44. The method of claim 42 in which associating the stored information comprises, on the computer:
automatically identifying a description of the product within the retrieved information; and
in communication with a second website, automatically
initiating generation of a web page to sell the product,
adding the description of the product to the web page, and
causing the web page to be available to potential buyers of the product.

45. The method of claim 44 also including identifying a resale price of the product within the retrieved information and adding the resale price to the web page.

46. A method comprising, on a computer:
automatically identifying a sales listing offering an identified product;
automatically locating stored information about the identified product in a store of information about products; and
associating the stored information with the sales listing for the identified product.

47. A medium bearing a data structure that includes:
a sequence of steps that can be automatically followed to interact with features of a website to locate information of a particular type.

48. A medium bearing instructions to cause a computer to:
automatically interact with a web site to determine a sequence of steps for interacting with features of the web site to locate information of a particular type; and
automatically storing, for later use, the determined sequence of steps.

49. The medium of claim 48 in which the instructions also cause the computer to:
receive an identification of a particular subject;
perform each step in the sequence of steps, including for at least one of the steps, retrieving from the web site information of the particular type related to the particular subject; and
provide the retrieved information.

50. A medium bearing instructions to cause a computer to:
automatically
access an identified website;
perform one or more of the following actions to reach a web page providing access to particular information:
follow at least one link having a characteristic associated with a page where a product can be selected, and
enter an identification of a first product in an input control of a page;
on the web page providing access to particular information, identify a link to particular information about the first product; and
return a list of the actions that led to the link to the particular information about the first product.

51. A medium bearing instructions to cause a computer to:
automatically identify a web site likely to provide information related to an identified subject; and
automatically follow a stored sequence of steps to interact with features of the website to locate information of a particular type related to the identified subject, including for at least one of the steps retrieving the information.

52. A medium bearing instructions to cause a computer to:
receive from a first tool a sequence of steps that can be automatically followed to interact with features of a website to locate information of a particular type;
associate with the sequence of steps an identification of the website; and
store the sequence of steps in a database.

53. A medium bearing instructions to cause a computer to:
receive from a first process a first sequence of steps for locating information of a particular type on a particular web site;
store the first sequence of steps in a database of sequences of steps;
upon identifying the particular web site as likely to provide information related to a particular subject,
retrieve the first sequence of steps from the database;
provide the first sequence of steps and an identification of the subject to a second process; and
receive from the second process information relating to the particular subject from the particular website.

54. A medium bearing instructions to cause a computer to:
automatically identify a sales listing offering an identified product;
automatically locate stored information about the identified product in a store of information about products; and
associate the stored information with the sales listing for the identified product.
